(19) United States
(12) Patent Application Publication
(10) Pub. No.: US 2013/0074619 A1
(43) Pub. Date: Mar. 28, 2013

(54) ROTARY SHAFT POSITIONING DEVICE

(71) Applicants: AN SZU HSU, NEW TAIPEI CITY (TW); CHIEN NAN TSAI, NEW TAIPEI CITY (TW)

(72) Inventors: AN SZU HSU, NEW TAIPEI CITY (TW); CHIEN NAN TSAI, NEW TAIPEI CITY (TW)

(73) Assignee: FIRST DOME CORPORATION, NEW TAIPEI CITY (TW)

(21) Appl. No.: 13/241,935

(22) Filed: Sep. 23, 2011

(51) Int. Cl. F16H 35/18

(52) U.S. Cl. 74/10.1

(57) ABSTRACT

A rotary shaft positioning device is a simplified structure provided with rotating and positioning actions. The rotary shaft positioning device includes a housing defined with a tank chamber, a rotator disposed in the tank chamber of the housing, and a reactor. The housing is formed as a type of geometrical section. The rotator including a limiting portion is rotated while being accompanied by the rotation of the rotary shaft. The reactor is configured in between the tank chamber of the housing and the rotator to constantly press on the rotator, so that the reactor and the rotator form an interference status therebetween. The reactor and the rotator relatively form a frictional resistance to attain a positioning action when the rotary shaft is rotated, thereby reducing the complication of the positioning assembly device and improving the overlength of the assembling configuration of the positioning mechanism in conventional skills.

### BACKGROUND OF THE INVENTION

1. Field of the Invention

The present invention relates to a rotary shaft device for electronic devices, and in particular relates to a combination of a rotary shaft and a positioning device to form rotating and positioning actions in the operation and assembling processes.

2. Description of the Related Art

Electronic devices, such as mobile phones, notebook computers, personal digital assistants (PDAs), digital cameras and E-books, are conventionally provided with pivotal shafts or rotary shafts, capable of being reciprocally rotated by an external force to open or close a cover, a display monitor or a viewing window thereof.

Referring to FIGS. 1 and 2, in this kind of conventional rotary shaft assembly, components formed with through holes “a”, such as washers 20, friction plates 21 and 22, and elastic elements 23, are often combined to a rotary shaft 10. Two ends of the rotary shaft 10) are respectively fixed by fasteners 24 and 25 to prevent the washers 20, the friction plates 21 and 22, and the elastic elements 23 from axial displacement, so that an axially-packing rotary shaft structure is formed. In conventional skills, a pivotal shaft or rotary shafts capable of being immediately positioned after rotation is disclosed.

One topic related to operation, movement and structural design of the case above is that embedded structures such as a positioning flange “b”, concaves “c” or concave-convex positioning portions are disposed on relative planes of washers, elastic plate or elastic elements, friction plates or the related components, so that a positioning function is formed when the positioning flange “b” is rotated to the site located with the concave “c” in the rotating operation of the rotary shaft 10. As known by those who skilled in the arts, when the positioning flange “b”, the concaves “c” or concave-convex positioning portions disposed on the relative matched planes applied in large electronic products are operated for a long-time period, the imperfect conditions such as abrasions caused by rigid contact are often occurred, and thus the quality of the positioning action of the embedded structures is reduced.

Another topic related to the structural design of the pivotal shaft or rotary shaft is that a combination of washers and friction plates applied in the conventional skills is incorporated with elastic rings or springs to store or release energy, to attain the rotating and positioning actions of the rotary shaft or pivotal shaft. However, the structural design and assembly installations of these conventional skills are more complicated, and herewith the assembling configuration of the structure in an axial direction is overlengthed (e.g., in FIGS. 1 and 2, the configuration space of the rotary shaft and electronic devices is limited). Thus, the above-described conditions in the conventional skills cannot meet the actual requirements.

These representative reference data above disclose the conditions of operative and structural designs related to the rotary shafts or the related components. Actually, the rotary shafts or the related components and the applications applied in the conventional skills still can be redesigned to reduce the complications of the structures and assembly installations and to increase the operation stability and serviceability of the high-torque or large-sized electronic products by altering the type of use, but a further improvement is not physically taught or disclosed in these reference data.

### BRIEF SUMMARY OF THE INVENTION

In view of this, the main purpose of the present invention is to provide a simplified rotary shaft positioning device provided with rotating and positioning actions. The rotary shaft positioning device includes a housing defined with a tank chamber, a rotator disposed in the tank chamber of the housing, and a reactor. The housing is formed as a type of geometrical section. The rotator including a limiting portion is rotated while being accompanied by the rotation of the rotary shaft. The reactor is configured in between the tank chamber of the housing and the rotator to constantly press on the rotator, so that the reactor and the rotator form an interference status therebetween. The reactor and the rotator relatively form a frictional resistance to attain a positioning action when the rotary shaft is rotated, thereby reducing the complication of the positioning assembly device and improving the overlength of the assembling configuration of the positioning mechanism in conventional skills.

According to the rotary shaft positioning device of the present invention, an elastic unit disposed between the housing and the reactor is utilized to assist the reactor being constantly pressed on the rotator. The reactor comprises a pivoting end and at least one free end formed with a blocking portion. The limiting portions of the rotator, corresponding to the blocking portion of the free end of the reactor, are formed as a type of grooves extended along a direction parallel to an axial direction of the rotator, thereby holding the blocking portion of the reactor by the limiting portion of the rotator. The blocking portions of the reactor faced toward the inner surface thereof are formed as a type of rib or ridge. The limiting portion of the rotator is formed as a type of groove extended along a direction parallel to an axial direction of the rotator. When the rotor is rotated while being accompanied by the rotation of a rotary shaft, the blocking portion of the reactor is entered in or left from the limiting portion of the rotator to form a positioning action.

According to the rotary shaft positioning device of the present invention, the reactor is formed as a type of similar annular elastomer comprising an opening, capable of providing an extension motion range and an elastic action force constantly pressing on the rotator. Therefore, the reactor generates extension or return motion in response to the rotation of the rotary. Actually, the reactor comprises a pivoting end and two free ends, wherein the pivoting end is formed as a type of embedded slot utilized to pivot to a pile disposed in a tank chamber of a housing, so that the reactor is installed in the tank chamber of the housing.

According to the rotary shaft positioning device of the present invention, a positioning mechanism for the rotation of the rotary shaft is established by the housing, and the reactor and the rotator which are assembled in the tank chamber of the housing. Therefore, the axial length of the housing, the reactor and the rotator assembled on the rotary shaft can be possibly minimized. In the application of the combination of the washers, the friction plates and the elastic plate in conventional skills, the conditions, such as the over-complication of the design and assembling process of the entire structure, and the configuration space limitation of the rotary shaft and electronic devices caused by the overlength of the assembling configuration length, can be highly improved.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional rotary shaft assembly using a combination of washers, friction plates and elastic elements;

FIG. 2 is an exploded schematic view of the structure of the conventional rotary shaft assembly in FIG. 1;

FIG. 3 is an outside perspective view of an embodiment of a combination of a rotary shaft and a positioning device of the invention;

FIG. 4 is an exploded schematic view of a partial structure in FIG. 3;

FIG. 5 is an exploded schematic view of the structure in FIG. 3, representing that the positioning device comprises a housing, a rotor and a reactor;

FIG. 6 is a sectional schematic view of the structure in FIG. 3, representing an assembled condition of a tank chamber of a housing, a rotor, a reactor and a rotary shaft;

FIG. 7 is another sectional schematic view of the structure in FIG. 3, representing an assembled condition that a rotor is rotated while being accompanied by the rotation of a rotary shaft and a reactor is formed with an extension motion;

FIG. 8 is yet another sectional schematic view of the structure in FIG. 3, representing an assembled condition that a rotor is rotated while being accompanied by the rotation of a rotary shaft and a reactor;

FIG. 9 is an exploded schematic view of a partial structure of a modified embodiment of the invention;

FIG. 10 is an exploded schematic view of the structure in FIG. 9, representing that the positioning device comprises a housing, a rotor and a reactor;

FIG. 11 is a sectional schematic view of the structure in FIG. 9, representing an assembled condition of a tank chamber of a housing, a rotor, a reactor and a rotary shaft;

FIG. 12 is another sectional schematic view of the structure in FIG. 9, representing an assembled condition that a rotor is rotated while being accompanied by the rotation of a rotary shaft and a reactor is formed with an extension motion;

FIG. 13 is another sectional schematic view of the structure in FIG. 9, representing an assembled condition that a rotor is rotated while being accompanied by the rotation of a rotary shaft and a reactor is partially formed with an extension motion;

FIG. 14 is a plan schematic view of the structure of another embodiment of the invention;

FIG. 15 is another sectional schematic view of the structure in FIG. 14, representing an assembled condition that a rotor is rotated while being accompanied by the rotation of a rotary shaft and a reactor is formed with an extension motion; and

FIG. 16 is yet another sectional schematic view of the structure in FIG. 14, representing an assembled condition that a rotor is rotated while being accompanied by the rotation of a rotary shaft and a reactor.

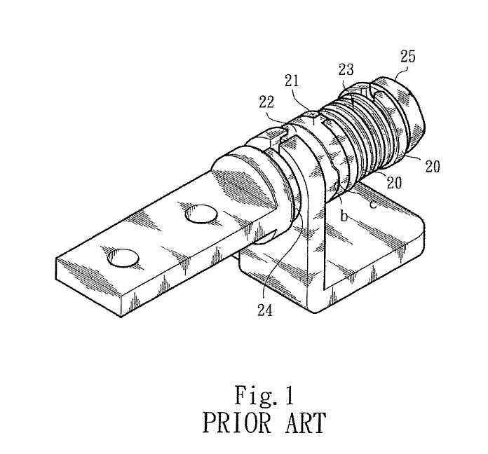

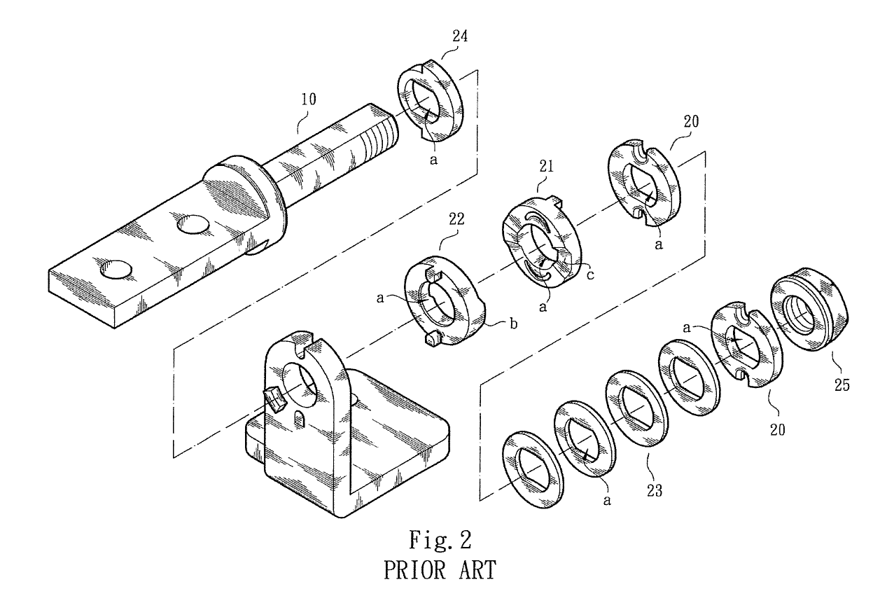

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

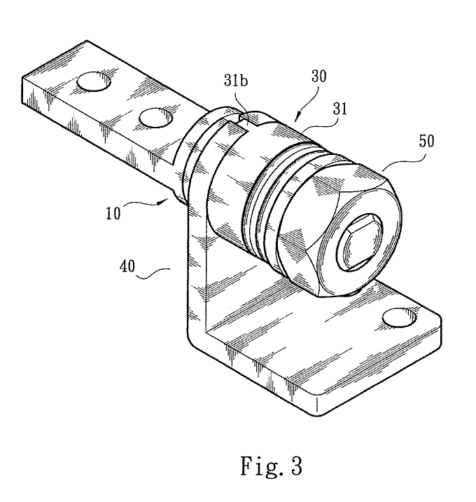

Referring to FIGS. 3, 4 and 5, a rotary shaft positioning device, comprises a rotary shaft 10 and a positioning device 30. The rotary shaft 10 is selected of a type of pillar body, capable of being fixed on a cover, a monitor or a display of an electronic device (not shown in FIGs.). The positioning device 30 comprises a housing 31, a rotator 32 having a bolt hole 32a, and a reactor 33. The housing 31 formed as a type of geometrical section is defined with a tank chamber 31a. In the adopted embodiment, the housing 31 is formed as a type of circular section, comprising a pile 31d disposed in tank chamber 31a and extended along a direction parallel to an axial direction thereof.

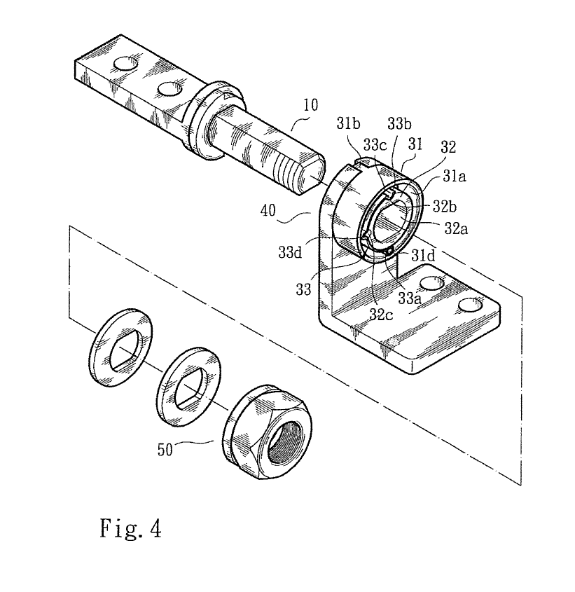

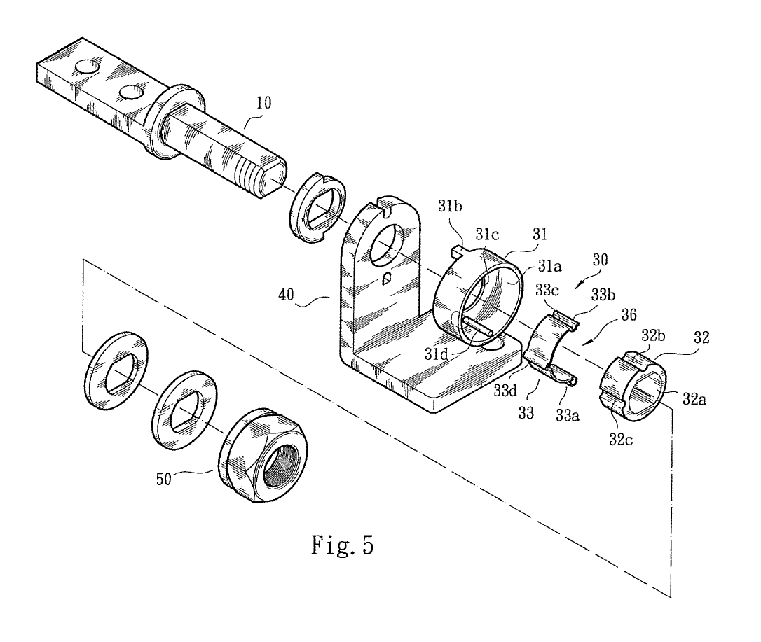

Referring to FIGS. 4 and 5, the housing 31 comprises a protrusion 31b and a through hole 31c communicated to the tank chamber 31a, wherein the housing 31 is fixed on a seat 40 by the protrusion 31b, and the rotary shaft 10 is entered into the tank chamber 31a of the housing 31 via the through hole 31c thereof to pivot to the rotator 32. Concretely speaking, the rotator 32 is assembled in the tank chamber 31a of the housing 31, and the bolt hole 32a of the rotator 32 is pivoted to the rotary shaft 10, so that the rotator 32 is rotated while being accompanied by the rotation of a rotary shaft 10. In FIGS. 4 and 5, the rotator 32 comprises a circular end surface and at least one limiting portion formed on the circular end surface. In the adopted embodiment, the rotator 32 comprises two limiting portions 32b and 32c spaced from each other at about 90 degrees.

Referring also to FIGS. 4 and 5, the reactor 33 is configured in the tank chamber 31a of the housing 31 and constantly pressing on the rotator 32 so that the reactor 33 and the rotator 32 form an interference status, and the reactor 33 and the rotator 32 relatively form a frictional resistance to attain a positioning action when the rotary shaft 10 is rotated. The reactor 33, selectively made of an elastic sheet-like material and formed as a type of similar circle or semicircle, comprises an opening 36 capable of providing an inward or inside-surface pressing action force to cause the reactor 33 itself to constantly press on the rotator 32. With the opening 36 of the reactor 33, it is understood that the reactor 33 can form an extension motion range, and also the size of the opening 36 of the reactor 33 can be varied in accordance with the design requirements.

In a preferred embodiment, the reactor 33 comprises an action portion 33d formed as a type of bent or protruded structure. The action portion 33d of the reactor 33 is utilized to assist in increasing the inward or inside-surface pressing action force of the reactor 33 on the rotator 32, capable of forming a larger extension motion range without permanent deformation.

In FIG. 5, the reactor 33 comprises a pivoting end 33a, at least one free end 33b, and at least one blocking portion 33c located between the pivoting end 33a and the free end 33b. In the adopted embodiment, the pivoting end 33a of the reactor 33 is pivoted to the pile 31d of the housing 31, so that the reactor 33 is assembled in the tank chamber 31a of the housing 31. The blocking portion 33c of the reactor 33, corresponding to the limiting portions 32b (or 32c) of the rotator 32, is disposed on the free end 33b and formed as a type of groove. The blocking portion 33c of the reactor 33 faced toward the inner surface thereof is formed as a type of rib or ridge. The limiting portions 32b and 32c of the rotator 32, corresponding to the blocking portion 33c of the free end 33b of the reactor 33, are formed as a type of grooves extended along a direction parallel to an axial direction of the rotator 32, thereby holding the blocking portion 33c of the reactor 33 by the limiting portion 32b (or 32c) of the rotator 32.

When the rotator 32 is rotated while being accompanied by the rotation of the rotary shaft 10, the blocking portion 33c of the reactor 33 can be relatively held in or release from by the limiting portion 32b (or 32c) of the rotator 32 for positioning, thereby simplifying the conditions such as structural complication of the components and large assembling length in conventional rotary shaft assembly. The related description will be mentioned hereinafter.

In a derivative embodiment, the structure of the blocking portion 33c of the reactor 33 and the structure of the limiting portion 32b (or 32c) of the rotator 32 can be inversed or altered. For example, the blocking portion 33c of the reactor 33 is formed as a type of groove, and the limiting portion 32b (or 32c) of the rotator 32 is formed as a type of rib or ridge.

In FIGS. 4 and 5, the tank chamber 31a of the housing 31 is fixedly sealed by a holder 50, so that the rotator 32 and the reactor 33 are assembled in the tank chamber 31a of the housing 31.

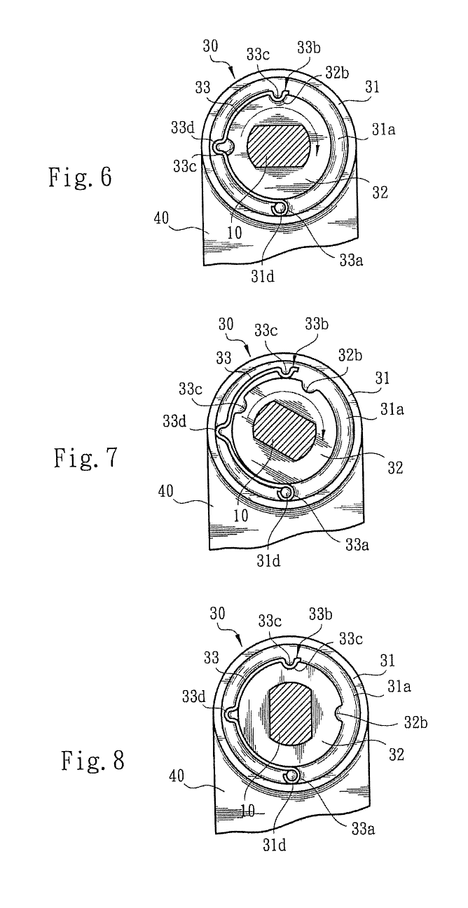

FIG. 6 represents an assembled condition of the rotary shaft 10, the tank chamber 31a of the housing 31, the rotator 32 and the reactor 33. Assumed that the cover, the monitor or the display of the electronic device are in a closed site or site, the free end 33b of the reactor 33 is initially located in the limiting portion 32b of the rotator 32. When an user forcedly operates the cover, the monitor or the display of the electronic device is rotated toward an open site, the rotary shaft 10 drives the rotator 32 to rotate in an arrow direction, so that the limiting portion 32b of the rotator 32 is left from the blocking portion 33c of the reactor 33 to force the reactor 33 forming an extension motion, as shown in FIG. 7.

It is understood that, due to the reactor 33 provided with the inward or inside-surface pressing action force capable of causing the reactor 33 itself to constantly press on the rotator 32, the rotary shaft 10 and the rotator 32 are stopped at the site shown in FIG. 7 when the force externally applied on the cover, the monitor or the display of the electronic device is released, and also the movement of the cover, the monitor or the display of the electronic device is stopped and positioned under the configuration type of the reactor 33 and the rotator 32, thereby positioning the cover, the monitor or the display of the electronic device at any rotation angles or sites.

Referring to FIG. 8, when the rotator 32 driven by the rotary shaft 10 is rotated at 90 degrees, the blocking portion 33c of the reactor 33 is correspondingly entered in the limiting portion 32c of the rotator 32, and the reactor 33 is returned to an initial non-extension status. Assumed that the cover, the monitor or the display of the electronic device are in an opening status or site, the cover, the monitor or the display of the electronic device is driven back to the closed site unless the user returns the rotary shaft 10 back to the site shown in FIG. 6.

It is understood that, based on the above-described operation of the embodiment, the amount, spacing angle or site of the limiting portions 32b or 32c of the rotator can be changed in accordance with the actual requirement, thereby altering the site or range of the cover, the monitor or the display of the electronic device in the opened status.

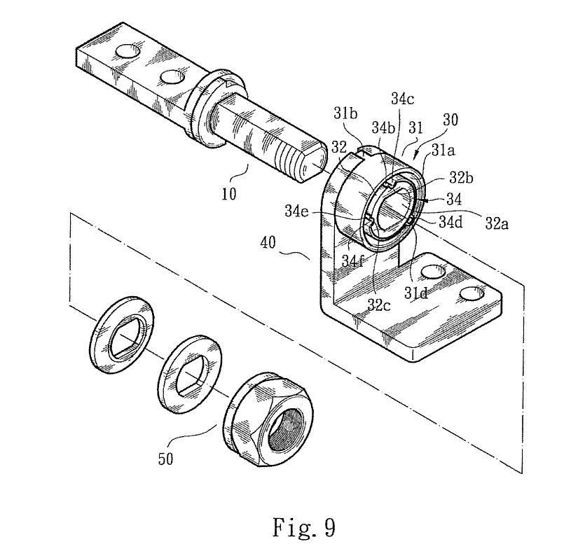

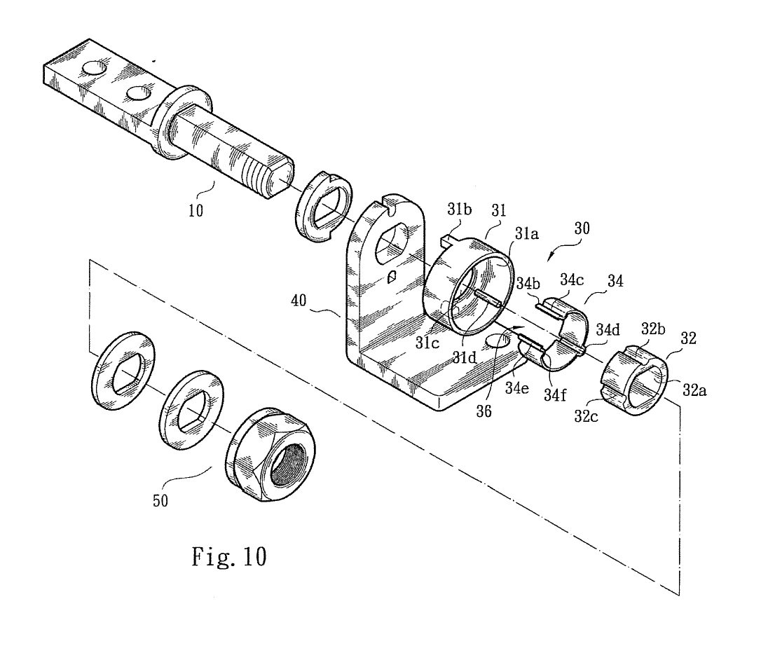

Referring to FIGS. 9 and 10, a modified embodiment of the invention is illustrated. The positioning device 30 comprises the housing 31, the rotator 32 and a reactor 34. In this embodiment, the reactor 34 comprises two free ends 34b and 34e and an action portion 34d located between the two free ends 34b and 34e, wherein the action portion 34d is utilized to assist in increasing the inward or inside-surface pressing action force thereof on the rotator 32 and to provide a larger extension motion range, and the action portion 34d also can be served as a pivoting end pivoted to the pile 31d of the housing 31, so that the reactor 34 is assembled in the tank chamber 31a of the housing 31.

In FIG. 10, the reactor 34 comprises two free ends 34b and 34e and two blocking portions 34c and 34f respectively located on the free ends 34b and 34e and corresponding to the limiting portions 32b and 32c of the rotator 32. The blocking portions 34c and 34f of the reactor 34 faced toward the inner surface thereof are formed as a type of rib or ridge.

The limiting portions 32b and 32c of the rotator 32, corresponding to the blocking portions 34c and 34f of the reactor 34, are formed as a type of grooves extended along a direction parallel to an axial direction of the rotator 32, thereby holding the blocking portions 34c and 34f of the reactor 34 by the limiting portions 32b and 32c of the rotator 32.

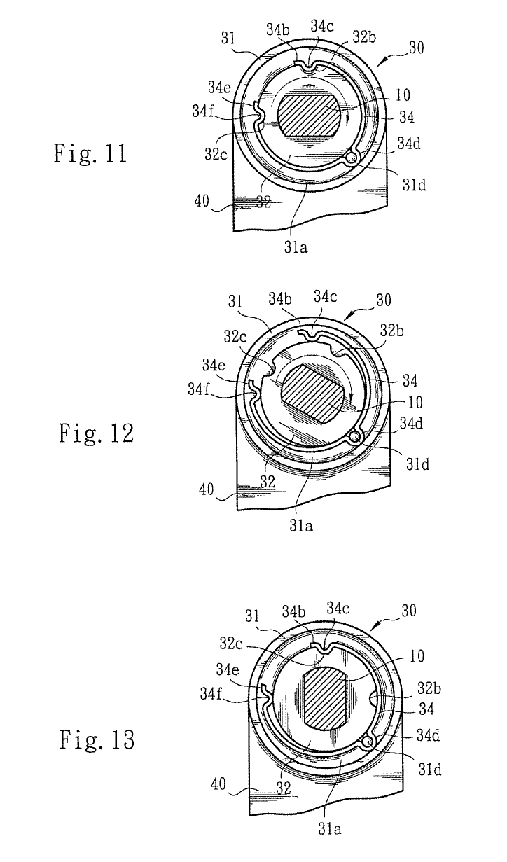

FIG. 11 shows an assembled condition of the rotary shaft 10, the tank chamber 31a of the housing 31, the rotator 32 and the reactor 34. Assumed that the cover, the monitor or the display of the electronic device are in a closed site or site, the free ends 34b and 34c of the reactor 34 are initially located in the limiting portions 32b and 32c of the rotator 32, respectively. When an user forcedly operates the cover, the monitor or the display of the electronic device is rotated toward an open site, the rotary shaft 10 drives the rotator 32 to rotate in an arrow direction, so that the limiting portions 32b and 32c of the rotator 32 are left from the blocking portions 34c and 34f of the reactor 34 to force the reactor 34 forming an extension motion, as shown in FIG. 12.

Referring to FIG. 13, when the rotator 32 driven by the rotary shaft 10 is rotated at 90 degrees, the blocking portion 34c of the reactor 34 is correspondingly entered in the limiting portion 32c of the rotator 32, and the blocking portion 34f of the reactor 34 is pressed on the circular end surface of the rotator 32, so that the reactor 34 is partially formed with an extension motion range. Assumed that the cover, the monitor or the display of the electronic device are in an open site, the cover, the monitor or the display of the electronic device is driven back to the closed site unless the user return the rotary shaft 10 back to the site shown in FIG. 6.

It is required to explain that, in comparison with the assembled conditions of the reactor 33 and the rotator 32 in FIG. 6 and the reactor 34 and the rotator 32 in FIG. 11, an angular positioning force of the positioning device 30 in FIG. 11 has twice as that in FIG. 6.

FIGS. 14, 15 and 16 show another embodiment of the invention. The positioning device 30 comprises the rotary shaft 10, the tank chamber 31a of the housing 31, the rotator 32 and a reactor 35. In this embodiment, the reactor 35 comprises a pivoting end 35a and a free end 35b, wherein the pivoting end 35a is pivoted to the pile 31d of the housing 31, so that the reactor 35 is assembled in the tank chamber 31a of the housing 31. The reactor 35 is selectively made of an elastic sheet-like material (or a non-elastic material) and formed as a type of similar semicircle, capable of providing an inward or inside-surface pressing action force to cause the reactor 35 itself to constantly press on the rotator 32.

In this preferred embodiment in FIGS. 14, 15 and 16, an elastic unit 60 disposed between the housing 31 and the reactor 35 is utilized to assist the reactor 33 being constantly pressed on the rotator 32. In this embodiment, the elastic unit 60 is selected of a type of (compression) spring. The contact site of the elastic unit 60 and the reactor 35 is located between the pivoting end 35a and the free end 35b of the reactor 35. The elastic unit 60 is compressed to store energy therein when the reactor 35 is formed with an extension motion while being accompanied by the rotation of the rotator 32, or the elastic unit 60 releases the stored energy to the initial status thereof when the reactor 35 does not have an extension motion.

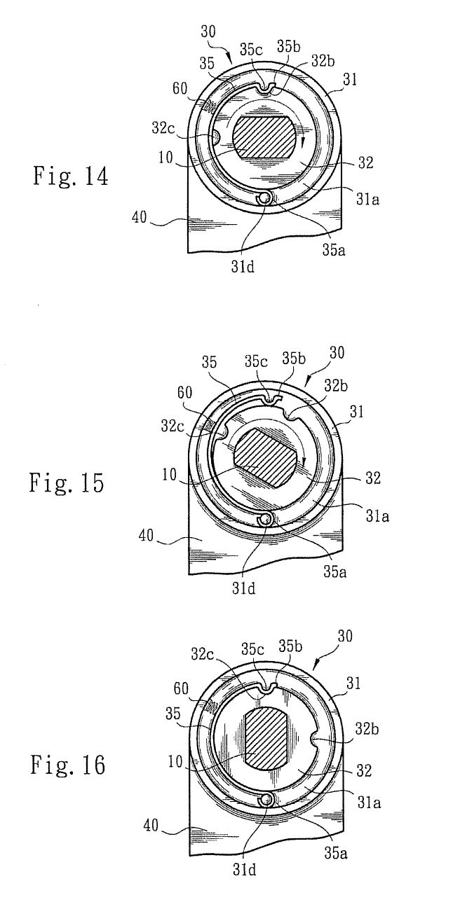

Referring again to FIG. 14, FIG. 14 shows an assembled condition of the rotary shaft 10, the tank chamber 31a of the housing 31, the rotator 32 and the reactor 35. Assumed that the cover, the monitor or the display of the electronic device are in a closed site or site, the free end 35b of the reactor 35 is initially located in the limiting portion 32b of the rotator 32. When an user forcedly operates the cover, the monitor or the display of the electronic device is rotated toward an open site, the rotary shaft 10 drives the rotator 32 to rotate in an arrow direction, so that the limiting portion 32b of the rotator 32 is left from the blocking portion 35c of the reactor 35 to force the reactor 35 forming an extension motion and to cause the elastic unit 60 storing therein, as shown in FIG. 15.

Referring to FIG. 16, when the rotator 32 driven by the rotary shaft 10 is rotated at 90 degrees, the blocking portion 35c of the reactor 35 is correspondingly entered in the limiting portion 32c of the rotator 32, the elastic unit 60 release the stored energy to assist the reactor 35 in returning to an non-extension status. Assumed that the cover, the monitor or the display of the electronic device are in an open site, the cover, the monitor or the display of the electronic device is driven back to the closed site unless the user returns the rotary shaft 10 back to the site shown in FIG. 14.

Representative speaking, in comparison with the conventional skills, the rotary shaft positioning device of the present invention provided with the conditions of rotating and positioning actions is representatively characterized with the considerations and advantages as follows.

First of all, by offering the redesigned rotary shaft 10 and the related component structures, such as the tank chamber 31a of the housing 31, the rotator 32 provided with the limiting portions 32b and 32c, the reactors 33, 34 and 35 capable of providing elastic motion types, the reactor 33 provided with the pivoting ends 33a, the action portion 33d and the blocking portion 33c, the reactor 34 provided with the action portion 34d and the two blocking portions 34c and 34f, and the reactor 35 provided with the pivoting end 35a and the blocking portion 35c, it is obvious that the present invention provides unique considerations different from the structural configuration of multiple washers and friction plates in conventional skills. Further, the conditions such as regular abrasions and unsuitable positioning actions occurred at the embedded structures of the positioning flanges, the concaves or the concave-convex positioning portions applied on the conventional components for a long-term operation can be also improved.

Secondly, with the assembling structure of the rotary shaft 10, and the housing 31, the rotator 32 and the reactor 33 (or 34 and 35) of the present invention, the design for the overall structure of washers and friction plates and the complicated assembly installations applied in conventional skills can be simplified; meanwhile, the configuration space of the rotary shaft and electronic devices limited by the overlength of the assembling configuration of the positioning mechanism in an axial direction in conventional skills can be improved.

With the configuration structure of the tank chamber 31a of the housing 31 and the mechanism of the reactor 33 (or 34 and 35) constantly pressing on the rotator 32 of the present invention, the cover, the monitor or the display of the electronic device can be positioned at any rotation angles or sites between an open site and a closed site.

In summary, the present invention provides a rotary shaft positioning device with spatial arrangement and advantages superior to the conventional skills. While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A rotary shaft positioning device, comprising:
a housing formed as a type of geometrical section and defined with a tank chamber;
a rotator disposed in the tank chamber of the housing; and
a reactor configured in the tank chamber of the housing and constantly pressing on the rotator, so that the reactor and the rotator form an interference status.

2. The rotary shaft positioning device as claimed in claim 1, wherein the reactor is located between the tank chamber of the housing and the rotator.

3. The rotary shaft positioning device as claimed in claim 1, wherein the housing is formed as a type of circular section.

4. The rotary shaft positioning device as claimed in claim 1, wherein the housing comprises a pile disposed in the tank chamber of the housing and extended along a direction parallel to an axial direction of the housing.

5. The rotary shaft positioning device as claimed in claim 1, wherein the housing comprises a protrusion and a through hole communicated to the tank chamber, and the housing is fixed on a seat by the protrusion.

6. The rotary shaft positioning device as claimed in claim 1, wherein the rotator comprises a bolt hole pivoted to the rotary shaft.

7. The rotary shaft positioning device as claimed in claim 1, wherein the rotator comprises a circular end surface and a limiting portion formed on the circular end surface.

8. The rotary shaft positioning device as claimed in claim 1, wherein the rotator comprises at least one limiting portion.

9. The rotary shaft positioning device as claimed in claim 8, wherein the rotator comprises two limiting portions spaced from each other at about 90 degrees.

10. The rotary shaft positioning device as claimed in claim 1, wherein the reactor is selectively made of an elastic sheet-like material.

11. The rotary shaft positioning device as claimed in claim 1, wherein the reactor is selectively made of an elastic sheet-like material and formed as a type of similar semicircle, comprising an opening.

12. The rotary shaft positioning device as claimed in claim 1, wherein the reactor comprises an action portion formed as a type of bent or protruded structure.

13. The rotary shaft positioning device as claimed in claim 1, wherein the reactor comprises a pivoting end and at least one free end.

14. The rotary shaft positioning device as claimed in claim 1, wherein the reactor comprises at least one blocking portion.

15. The rotary shaft positioning device as claimed in claim 1, wherein the reactor comprises an inner surface and at least one blocking portion faced toward the inner surface and formed as a type of rib or ridge.

16. The rotary shaft positioning device as claimed in claim 8, wherein the limiting portion of the rotator is formed as a type of groove extended along a direction parallel to an axial direction of the rotator.

17. The rotary shaft positioning device as claimed in claim 1, wherein the reactor comprises at least one blocking portion formed as a type of groove.

18. The rotary shaft positioning device as claimed in claim 8, wherein the limiting portion of the rotator is formed as a type of rib or ridge.

19. The rotary shaft positioning device as claimed in claim 1, wherein the tank chamber of the housing is sealed by a holder.
